(19) United States
(12) Patent Application Publication
(10) Pub. No.: US 2010/0139374 A1
(43) Pub. Date: Jun. 10, 2010

(54) METHODS FOR RHEOLOGICAL TESTING OF MULTIPLE SAMPLES AND SYSTEMS THEREFOR

(76) Inventors: Daniel L. Dermody, Midland, MI (US); Suraj S. Deshmukh, Midland, MI (US); Matthew T. Bishop, Midland, MI (US); Drew A. Davidock, Lake Jackson, TX (US); J. Keith Harris, Midland, MI (US); Tzu-Chi Kuo, Midland, MI (US); Paul L. Morabito, Midland, MI (US); Melissa A. Mushrush, Midland, MI (US); Donald W. Patrick, Midland, MI (US); Jonathan J. Zieman, Sanford, MI (US)

Correspondence Address: The Dow Chemical Company, P.O. BOX 1967, Midland, MI, 48641, US

(21) Appl. No.: 12/630,105

(22) Filed: Dec. 3, 2009

Related U.S. Application Data
(60) Provisional application No. 61/119,390, filed on Dec. 3, 2008.

(51) Int. Cl. G01N 11/02

(52) U.S. Cl. 73/54.02

(57) ABSTRACT

The viscosity or relative viscosity of samples can be measured in parallel by dispensing or aspirating the samples at a set condition and then measuring a property of the sample such as mass dispensed or aspirated.

### CROSS-REFERENCE STATEMENT

This application claims the benefit of priority from U.S. Provisional Patent Application No. 61/119,390, filed Dec. 3, 2008, which application is incorporated by reference herein in its entirety.

### FIELD OF THE INVENTION

The present invention generally relates to systems and methods for testing a plurality of samples in parallel and in particular to systems and methods for screening the plurality of samples based on their rheological property.

### BACKGROUND

Combinatorial chemistry is a relatively new area of research aimed at rapid synthesis and testing methods to build libraries of polymeric, organic, inorganic or solid state materials. The term “combinatorial chemistry” generally refers to methods and materials for creating collections of diverse materials or compounds commonly known as libraries and to techniques and instruments for evaluating or screening libraries for desirable properties. For example, combinatorial chemistry techniques with the aid of high-throughput systems have empowered chemists to rapidly produce large libraries of discrete organic molecules in the pursuit of discovery of new materials or materials with desirable properties thus reducing the time frame of these discoveries. Consequently, the discovery of new materials with novel chemical and physical properties can depend largely on the ability to analyze the new materials.

An important analytical tool for rapid testing or screening of the new materials or materials with new properties is to test the sample materials based on their rheological property such as a viscosity. Viscosity measurements find applications ranging from medical diagnostics and research to the chemical and manufacturing industry. For example, in the paints industry, viscosity measurements aid in characterizing the fabrication and thickness of paints, varnishes and coatings. Similarly, characterizing the viscosity of inks helps in ensuring uniform print and avoidance of smearing in both off-set and ink jet printing.

The two commonly used commercial viscometers are the cone and plate viscometer and the capillary viscometer. In the cone and plate viscometer, sample liquid is sheared between an inverted rotating cone and a stationary flat plate, and the torque required to turn the cone at a known angular velocity determines the viscosity. While comparatively expensive, the cone and plate viscometer allows analysis of all aspects of rheological behavior. In capillary viscometers sample liquid is made to flow through a capillary tube under a known pressure difference and the measured rate of flow is used to calculate the viscosity. The capillary viscometer, though inexpensive and simple to use, is mostly limited to Newtonian liquids due to the fact that the velocity in the tube and, therefore, the shear rate is constant.

Most current viscometers are designed predominantly as bench-top instruments and are difficult to use at the point of sample generation. Moreover, simultaneous measurements of multiple samples are not possible using some of these systems as they are serial in nature. Another drawback of some of these systems is that they require cleanup before each viscosity measurement thus their deployment in high-throughput systems are limited. A commercial viscometer used to be available which could measure the viscosity of the samples from the pressure change while aspirating or dispensing the samples through a capillary. One particular drawback of the capillary viscometer was that it was serial in nature, being able to measure only one sample at a time. Moreover, the capillary viscometer was not equipped to handle non-Newtonian fluids. Accordingly, it would be desirable to rapidly test, classify and screen multiple samples based on the rheological property of these samples in parallel thus saving sampling time.

### SUMMARY OF THE INVENTION

In one embodiment, a method of testing a plurality of samples in parallel is provided. The method includes providing a plurality of receptacles. The method further includes providing an automated liquid handler having at least two channels, each having a tip and operable to dispense the plurality of samples in the plurality of receptacles at a set dispensing condition, or to aspirate the plurality of samples from the plurality of receptacles at a set aspiration condition or both. The method further includes aspirating the plurality of samples from the plurality of receptacles or dispensing the plurality of samples in the plurality of receptacles, or both. A property of each of the plurality of samples is measured. The property is selected from mass of each of the plurality of samples dispensed in the plurality of receptacles, volume of each of the plurality of samples dispensed in the plurality of receptacles, flow rate while aspirating the plurality of samples or while dispensing the plurality of samples, time for aspirating the plurality of samples or for dispensing the plurality of samples, pressure differential across the at least two channels while aspirating each of the plurality of samples or while dispensing each of the plurality of samples, and any combinations thereof. The method further includes relating the property to a rheological property of each of the plurality of samples.

In another embodiment, a system for testing a plurality of samples in parallel is provided. The system includes a plurality of receptacles and an automated liquid handler having at least two channels. The at least two channels have a tip for aspirating the plurality of samples from the plurality of receptacles at a set aspiration condition, or dispense the plurality of samples in the plurality of receptacles at a set dispensing condition, or both. The system further includes a device for measuring a property of each of the plurality of samples. The property is selected from mass of each of the plurality of samples dispensed in the plurality of receptacles, volume of each of the plurality of samples dispensed in the plurality of receptacles, flow rate while aspirating the plurality of samples or while dispensing the plurality of samples, time for aspirating the plurality of samples or dispensing the plurality of samples, pressure differential across the at least two channels while aspirating the plurality of samples or while dispensing the plurality of samples, and any combinations thereof. A data analysis system is provided which is configured to analyze the property of each of the plurality of samples and relate it to a rheological property of each of the plurality of samples.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a system for testing a plurality of samples in parallel according to some embodiments of the present invention;

FIG. 2 is a plot of actual volume transferred against set aspiration volume of plurality of samples in accordance with embodiments of the present invention;

FIG. 3 is a schematic diagram of yet another system for testing a plurality of samples in parallel according to one embodiment of the present invention;

FIG. 4 is a plot of pressure while aspirating the plurality of samples against time according to some embodiments of the present invention; and

FIG. 5 is a flow chart of a method of testing a plurality of samples in accordance with embodiments of the present invention.

### DETAILED DESCRIPTION

As used herein, the term “test” refers to relative screening of the plurality of samples whereby the rheological property of plurality of samples is determined relative to each other. In some embodiments, rheological property of the plurality of samples is determined with reference to at least one sample of known rheological property. The term “test” as used herein also refers to determining individual rheological property of each of the plurality of samples.

As used herein, the term “viscosity” is defined as a measure of a resistance of a fluid to flow when subjected to a force, which induces a shear stress. Reference herein to viscosity is not intended to exclude the employment of viscosity measurements to determine other properties recognized as interdependent upon the measurement of viscosity, including, but not limited to, density, and temperature dependent properties of materials, pressure dependent properties of material, velocity/flowrate dependent properties of materials or the like. The term “rheological property” as used herein refers to study of flow behavior of fluids, or deformation of fluids in response to applied stress or strain.

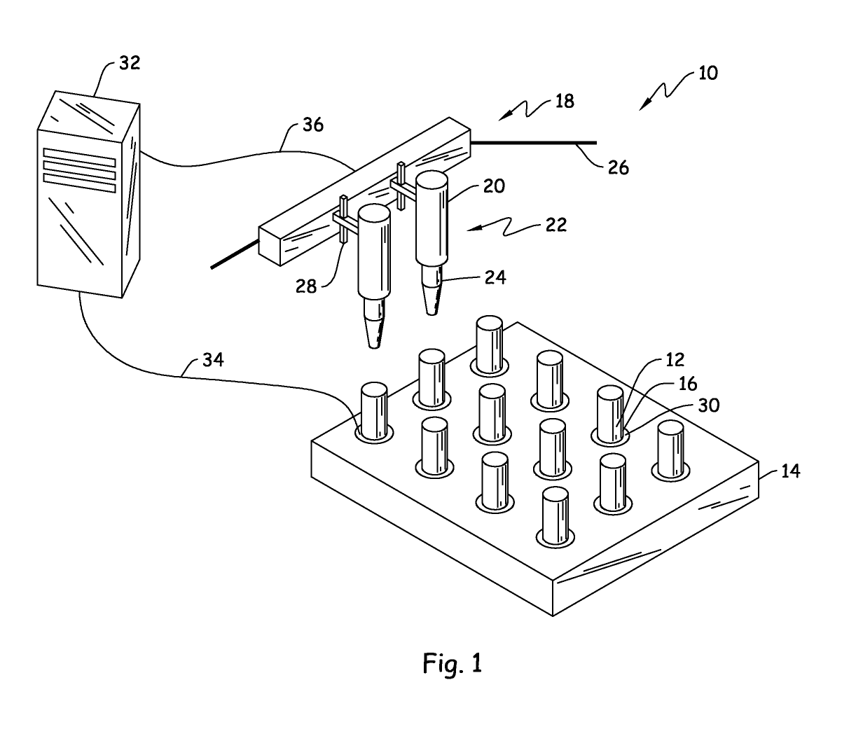

FIG. 1 is a schematic diagram of a system 10 for testing a plurality of samples 12 in parallel, in accordance with embodiments of the present invention. In some embodiments, the system 10 includes a substrate 14 having plurality of receptacles 16 for receiving and/or holding the plurality of samples 12. In some embodiments, the plurality of receptacles 16 forms part of the substrate 14. In certain embodiments, the plurality of receptacles 16 can be plurality of recesses (not shown) on the substrate 14. In one embodiment, the plurality of receptacles 16 is provided over the substrate 14. In certain other embodiments, the substrate 14 includes a plurality of recesses on which the plurality of receptacles 16 is placed. For example, the substrate 14 can be a standard titer-plate for high-throughput module commercially available from Symyx Technolgies, Inc., Santa Clara, Calif., having the plurality of receptacles 16. Exemplary plurality of receptacles 16 includes vials, watch glasses, test-tubes, cuvettes, trays and reservoirs. Without any limitation, the plurality of receptacles 16 and/or the substrate 14 can be of any shape and/or size. In some embodiments, the shape and/or size of the plurality of receptacles 16 and the substrate 14 can be modified to accommodate a volume of the plurality of samples 12. In one embodiment, the plurality of receptacles 16 has a cylindrical shape with an outer diameter in a range of about 0.5 centimeters to about 2 centimeters, and a length in the range of about 2 to 10 centimeters, preferably 4 centimeters to about 7 centimeters. In certain embodiments, the shape and/or size of the plurality of receptacles 16 and/or the substrate 14 can be influenced by a design of the high-throughput module or a component of the high-throughput module. The substrate 14 and/or plurality of receptacles 16 can be made of any suitable material that is chemically compatible with the plurality of samples 12. For example, the substrate 14 can be made of steel and the plurality of receptacles 16 can be made of glass.

The system 10 includes an automated liquid handler 18 operable to transfer the plurality of samples 12 to and/or from the plurality of receptacles 16. Embodiments of the present invention can employ any automated liquid handler 18, that are available commercially. In one embodiment, the automated liquid handler 18 is MicroLab® STAR available from Hamilton Company. The handler is preferably calibrated to at least one sample of known viscosity profile. If a plurality of samples of differing viscosity is transferred by automated liquid handler without any calibration, the actual amount of each of the plurality of samples transferred would scale according to viscosity of each of the plurality of samples. Embodiments of the present invention make use of this particular limitation of the automated liquid handlers while handling plurality of samples of differing viscosities to determine the rheological property of each of the plurality of samples.

Typically, the automated liquid handler for handling small volumes of samples of microliter or sub-microliter range includes a channel within, and a pump for aspirating and/or dispensing the plurality of samples through the channel. The method of operation can be using the principle of either air displacement or liquid displacement within the channel of the automated liquid handler. In the air displacement method, an internal plunger driven by the pump can be employed to push an air column up and down the channel of the liquid handler. The movement of the air column across the channel creates a vacuum which drives the sample inside the column, which is then released while dispensing the sample. In the liquid displacement method, the channel includes a working fluid and optionally an air gap where the air gap separates the working fluid from the sample thus preventing contamination.

The automated liquid handler 18 can handle plurality of samples 12 of the liquid form. In certain embodiments, the plurality of samples 12 can be of semi-solid form, such as gels. Exemplary plurality of samples 12 that can be handled using the automated liquid handler 18 include emulsions, blends, dispersions, melts, polyelectrolytes, oils, greases and pastes. Without any limitation, the plurality of samples 12 can be lubricants, catalyst formulations, agrochemicals, paint formulations, elastomers, polymeric solutions, polymer melts, polyelectrolytes, water soluble polymeric compositions, cellulosic compositions, food thickeners, personal care formulations or any combinations thereof. In some embodiments, the plurality of samples 12 can be a formulation having a composition including at least one common ingredient. In certain embodiments, the plurality of samples 12 has no common ingredient.

The plurality of samples 12 can have a viscosity in the range of about 1 cP to about 1000000 cP, in some embodiments. In another embodiment, the plurality of samples 12 can have a viscosity in the range of about 1 cP to about 2,50,000 cP. In some embodiments, the plurality of samples 12 includes at least one sample of known rheological property. Example samples of known rheological property include commercially available viscosity standards fulfilling ASTM D445 methods, for example from Cannon Instrument Company, State College, Pa. 16804.

The automated liquid handler 18 has an arm 20 defining a channel 22 within the arm 20 for passage of plurality of samples 12 therethrough. The channel 22 has a tip 24 at one end of the channel 22 through which the plurality of samples 12 enter or exit the channel 22 of the arm 20. In FIG. 1, the automated liquid handler 18 has at least two arms 20 having channels 22 within, for handling the plurality of samples 12 in parallel. As will be appreciated, when the automated liquid handler 18 has two channels 22 for passage of the plurality of samples 12, two of the plurality of samples 12 can be handled in parallel. In some embodiments, the automated liquid handler 18 has at least four arms 20 having channels 22 within, each of those four channels 22 having a tip 24 to transfer plurality of samples 12 in parallel. In certain other embodiments, the automated liquid handler 18 has at least eight arms 20 having channels 22 within, each of those eight channels 22 having a tip 24 to transfer the plurality of samples 12 in parallel. In one embodiment, the automated liquid handler 18 has ninety six arms 20 having channels 22 within, each of those ninety six channels 22 having a tip 24 to transfer the plurality of samples 12 in parallel. In some embodiments, each of the channels 22 of the automated liquid handler 18 is independently controlled.

In some embodiments, the automated liquid handler 18 includes a syringe (not shown) having a channel within, through which a plunger is displaced to and fro, to create a vacuum for aspirating the plurality of samples 12. A needle (not shown) can be provided at one end of the channel through which the plurality of samples 12 can be aspirated or dispensed.

In one embodiment, the tip 24 or the needle of the automated liquid handler is disposable and can be replaced after each use. In certain embodiments, the tip 24 or the needle is not disposable and can be washed before each use. The tip 24 and the needle can be made of any suitable material that is chemically compatible with the plurality of samples 12. For example, the tip 24 and the needle can be made of steel.

In one embodiment, the tip 24 can be modified. In some embodiments, modifying the tip 24 includes modifying a diameter of the tip 24, or a length of the tip 24, or a shape of the tip or any combinations thereof. In certain embodiments, the tip 24 can be modified to include the range of rheological properties to be determined. In one embodiment, the diameter of the tip 24 is increased to broaden the range of viscosity to be determined.

The automated liquid handler 18 has to be positioned and aligned with the plurality of receptacles 16 of the substrate 14 to transfer the plurality of samples 12 to and/or from the plurality of receptacles 16. In some embodiments, the automated liquid handler 18 can be provided adjacent to the substrate 14. In certain embodiments, the automated liquid handler 18 can be mounted on the substrate 14. As shown in FIG. 1, the automated liquid handler 18 is provided adjacent to the substrate 14 on a first translation mechanism 26 capable of positioning the automated liquid handler 18 in X-Y direction with respect to the substrate 14. In certain embodiments, the substrate 14 can be mounted on a translation stage (not shown) for X-Y motion of the substrate 14 with respect to the automated liquid handler 18. The arm 20 of the automated liquid handler 18 can be mounted on a second translation mechanism 28 for upward and downward motion of the arm 20 with respect to the plurality of receptacles 16. In some embodiments, the translation mechanisms 26 and 28 and the translation stage can be automatically controlled by means of a computer or a control system.

The automated liquid handler 20 can be operated at a set dispensing condition to transfer plurality of samples 12 on the plurality of receptacles 16. In some embodiments, the automated liquid handler 20 is operated at a set aspiration condition to transfer plurality of samples 12 from the plurality of receptacles 16. As used herein, the terms “set aspiration condition” and “set dispensing condition” refers to the settings used by the automated liquid handler for aspirating and/or dispensing the plurality of samples. Such settings can include a set aspiration rate, a set dispensing rate, a set settling time, a set aspiration volume and a set dispensing volume. For the material for which the automated liquid handler has been calibrated, the settings will match or substantially match the actual condition or other rate. However, if a material of different viscosity is transferred the actual measured property is likely to deviate from the set condition or the predicted property based on the known material. This enables one to analyze the viscosity or relative viscosity of a number of samples. The terms “set aspiration rate and set dispensing rate” refers to the automated liquid handler 18 settings indicating the rate at which samples of the calibration material are aspirated and/or dispensed. As used herein, the terms “set aspiration volume and set dispensing volume” refers to the automated liquid handler 18 settings indicating the volume set for aspiration or the volume set for dispensing, respectively. As used herein, the term “settling time” refers to time set between each operation. As will be appreciated, operating at a set aspiration condition or at a set dispensing condition will transfer plurality of samples 12 of a property. Embodiments of the present invention correlate the property of the plurality of samples 12 aspirated or dispensed to the rheological property of each of the plurality of samples 12.

According to one embodiment device 30 is provided to measure a property of each of the plurality of samples 12. The property measured is selected from mass of each of the plurality of samples 12 dispensed in the plurality of receptacles 16, volume of each of the plurality of samples 12 dispensed in the plurality of receptacles 16, flow rate while aspirating the plurality of samples 12 or while dispensing the plurality of samples 12, time for aspirating the plurality of samples 12 or for dispensing the plurality of samples 12 and any combinations thereof. When the property measured is mass of each of the plurality of samples 12, the device 30 is a weighing balance, as shown in FIG. 1. Other devices 30 to measure the mass of the plurality of samples 12 can include a piezoelectric device or a transducer operable to measure mass of each of the plurality of samples 12. In another embodiment, property measured can be volume of each of the plurality of samples 12. In one embodiment, the property measured is volume of each of the plurality of samples 12 and the device 30 can be an optical device (not shown) operable to record a height of each of the plurality of samples 12 on the plurality of receptacles 16, where the height can be related to a rheological property of each of the plurality of samples 12. In some embodiments, the device 30 can be the plurality of receptacles 16 that are graduated to display volume of each of the plurality of samples 12 in the plurality of receptacles 16.

The device 30 can be a single device operable to measure the property of each of the plurality of samples 12. In some embodiments, the device 30 can be more than one device. In embodiments having more than one device 30, these devices can be interlinked.

In FIG. 1, the device 30 is provided over the substrate 14, and the plurality of receptacles 16 are provided on the device 30. The device 30 is operable to measure a change in mass on receiving the plurality of samples 12 on the plurality of receptacles 16. In some embodiments, the plurality of receptacles 16 is pre-weighed or tare weighed. The difference in weight, that is, the weight of the plurality of receptacles 16 with the plurality of samples 12 to the weight of the plurality of receptacles 16 provides mass of each of the plurality of samples 12. However, the device 30 need not be adjacent to the substrate 14. In some embodiments, a robotic arm or an automated system can be employed to transfer the plurality of receptacles 16 to the device 30 for measuring the weight of the plurality of samples 12.

The property measured using the device 30 can be analyzed using a data analysis system 32. In one embodiment, the data analysis system 32 relates the property measured to the rheological property of each of the plurality of samples 12 by analyzing at least one of the actual volume, mass, flow rate and time for aspirating and/or dispensing each of the plurality of samples 12 at the set aspiration condition or the set dispensing condition. As will be appreciated, the sensitivity and the range of the rheological property determined can be tuned by modifying the set aspiration condition, or the set dispensing condition or both. Thus, in one embodiment, the data analysis system 32 is configured to measure the property of each of the plurality of samples 12 at a modified set aspiration condition or a modified set dispensing condition or both. For example, an appropriate set aspiration rate can be chosen for plurality of samples 12, whereby a contrast in the property measured can be enhanced thereby increasing the sensitivity of the system 10. In one example, for a sample such as water having a viscosity of about 1 cP at 20 degrees Celsius, a higher set aspiration rate can be used, while for a sample such as honey having a viscosity of about 10,000 cP at 20 degrees Celsius, a lower set aspiration rate can be employed.

In some embodiments, the data analysis system 32 is in a feed-back loop 34 with the device 30 and is operable to send signals to the device 30 and/or receive signals from the device 30. For example, the data analysis system 32 can receive a signal on mass and/or volume of each of the plurality of samples 12 dispensed on the plurality of receptacles 16 from the device 30. In some embodiments, the data analysis system 32 is in a feed-back loop 36 with the automated liquid handler 18 and the device 30. For example, the data analysis system 32 can send signals to automated liquid handler 18 to dispense the plurality of samples 12 at set dispensing condition and upon receiving the plurality of sample 12, the device 30 can be operable to send signals on mass and/or volume of each of the plurality of samples 12 dispensed on the plurality of receptacles 16 to the data analysis system 32, where the signals on mass and/or volume of each of the plurality of samples 12 can be correlated to the rheological property of each of the plurality of samples 12. In one embodiment, the data analysis system 32 can be programmed to control operation of the automated liquid handler 18, the plurality of receptacles 16 and/or the device 30. In some embodiments, the data analysis system 32 can be a computer (not shown) interfaced with the device 30, the plurality of receptacles 16 and/or the automated liquid handler 18.

In one embodiment, the data analysis system 32 can relatively screen the plurality of samples 12 based on the property measured by the device 30 by aspirating the plurality of samples 12 at set aspiration condition, or by dispensing the plurality of samples 12 at set dispensing condition. The data analysis system 32 can sort the plurality of samples 12 from the mass and/or volume of each of the plurality of samples 12 dispensed on the plurality of receptacles 16. As will be appreciated, for a set aspiration or dispense condition such as set aspiration rate or set dispensing rate, the actual mass and/or volume of the plurality of samples 12 on the plurality of receptacles 16 having higher viscosity will be lower than the mass and/or volume of the plurality of samples 12 having lower viscosity. In one embodiment, the data analysis 32 can screen the plurality of samples 12 by comparing the property of the plurality of samples 12 with respect to each other. In another embodiment, the data analysis system 32 can screen the plurality of samples 12 for desired property, from the expected mass and/or volume for the desired property.

In some embodiments, an empirical correlation can be formulated between the property measured of the plurality of samples 12 and the rheological property of the plurality of samples 12. In certain embodiments, the data analysis system 32 can determine the rheological property of the plurality of samples 12 from the empirical correlation. In some embodiments, a calibration curve or a standard curve can be generated based on the empirical correlation. In one embodiment, a standard curve can be generated for at least one of the plurality of samples 12 by transferring at more than one set aspiration volume while keeping the other settings of the automated liquid handler 18 fixed. The measured property of each of the plurality of samples 12 can be compared to the standard curve and the rheological property can be determined.

In some embodiments, the plurality of samples 12 can include at least one sample of known rheological property. In one embodiment, at a set aspiration volume, the mass and/or volume transferred of at least one sample of known rheological property can be measured to obtain a standard and/or standards. From the standard, rheological property of each of the plurality of samples 12 can be determined. In some embodiments, a standard curve can be obtained by generating a first plot of set aspiration volume against mass and/or volume transferred of plurality of samples 12 of known rheological property. The rheological property of each of the plurality of samples 12 can then be determined from the first plot by knowing the set aspiration volume against mass and/or volume transferred of each of the plurality of samples 12. In one embodiment, data analysis system 32 is operable to determine the rheological property from the set aspiration volume against mass and/or volume transferred. In another embodiment, the data analysis system 32 is operable to generate the first plot and determine the rheological property of each of the plurality of samples 12. The plurality of samples 12 that is tested remains undamaged after determining their rheological properties.

In some embodiments, the data analysis system 32 is operable to measure the property of each of the plurality of samples 12 as a function of time, composition, temperature, or any combinations thereof. In one embodiment, the system 10 is enclosed in an environmentally controlled chamber (not shown). In some embodiments, the system 10 includes a means for controlling and/or maintaining at least one of a temperature, humidity and atmosphere within the chamber. In certain other embodiments, the temperature of the tip 24 of the automated liquid handler 18 and/or the plurality of samples 12 can be controlled and/or maintained. In some embodiments, the system 10 includes a temperature controller (not shown) to maintain and/or control the temperature of the plurality of samples 12, or the tip 24, or both. In one example, the rheological property measured is viscosity as a function of temperature such as freeze thaw stability. For example, weathering effects on paint formulations can be determined by subjecting the plurality of samples through cycles of freezing and room temperature conditions and comparing the viscosity of each of the plurality of samples 12 at these temperature conditions to determine the plurality of samples 12 that exhibit better freeze thaw stability. Other properties that are related to viscosity of the plurality of samples 12 which can be determined using embodiments of the present invention include heat age stability, pour point, yield point, pot life, cure point, shear thinning, phase stability, temperature stability, shear thickening or any combinations thereof. In some embodiments, composition of the plurality of samples 12 can be varied and the rheological property of the plurality of samples 12 can be determined as a function of the composition. In one embodiment, one of the ingredients that constitute the plurality of samples 12 can be varied and the viscosity of the plurality of samples 12 with respect to the ingredient can be determined. In yet another embodiment, composition of the plurality of samples 12 can be varied and the rheological property of the plurality of samples 12 can be determined as a function of the composition as well as a function of temperature.

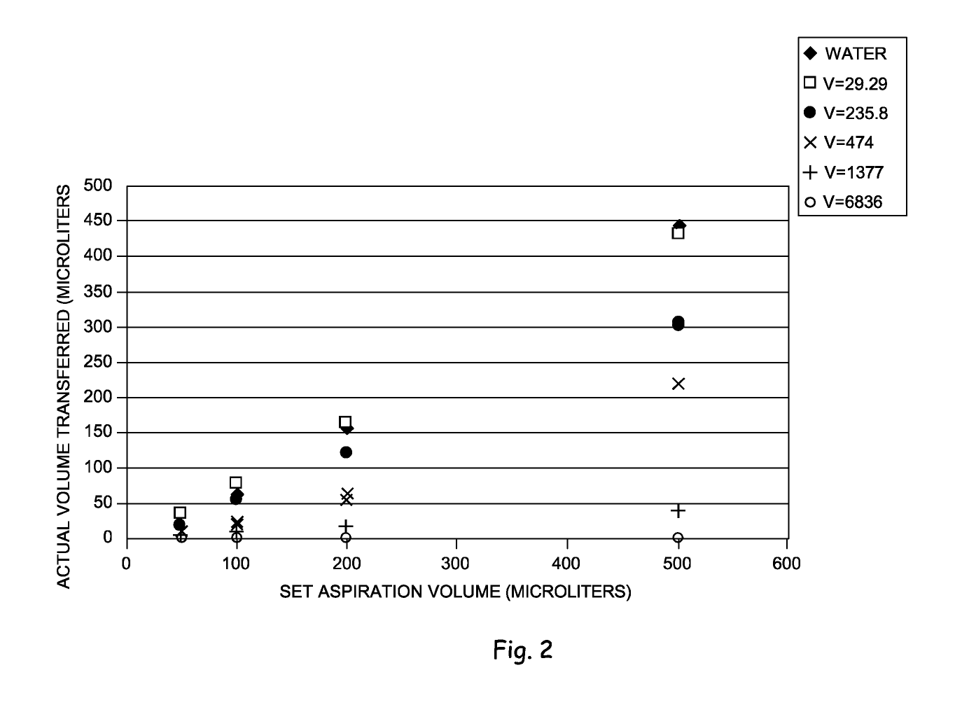

FIG. 2 is a plot of actual volume transferred in microliters against set aspiration volume in microliters of plurality of samples of known rheological property at a set aspiration rate of 200 microliters per second using 1 milliter standard tips. FIG. 2 shows that as the viscosity of the plurality of samples increases, the volume transferred against set aspiration volume decreases. Advantageously, viscosities of plurality of samples can be determined from the first plot by plotting the volume actually transferred against set aspiration volume and comparing with that of samples of known rheological properties.

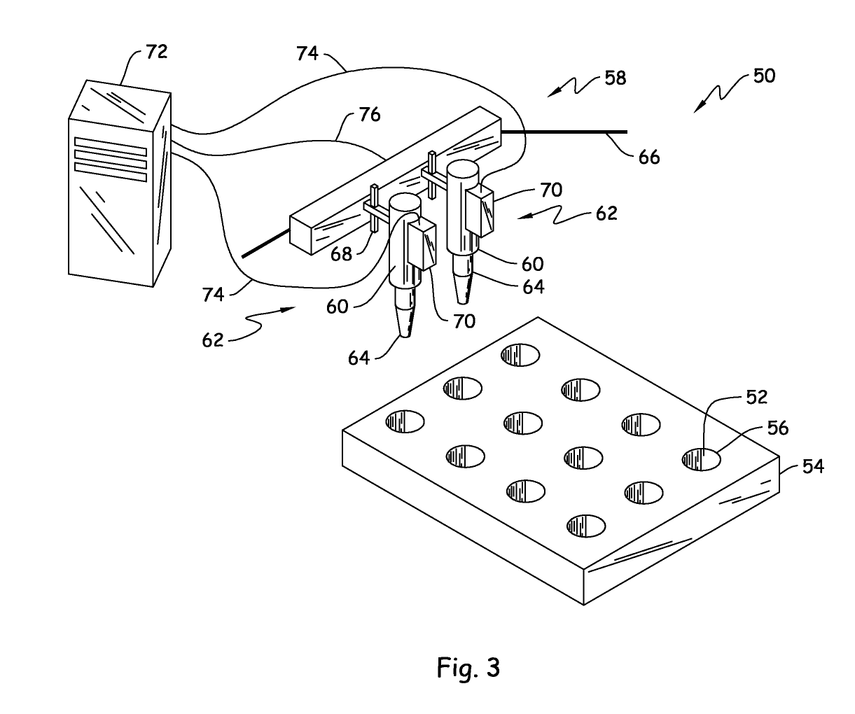

A schematic diagram of a system 50 for testing a plurality of samples 52 in parallel, in accordance with embodiments of the present invention, is shown in FIG. 3. The system 50 includes a substrate 54 having plurality of receptacles 56 for receiving and/or holding the plurality of samples 52. The plurality of samples 52, substrate 54 and plurality of receptacles 56 are similar to the plurality of samples 12, substrate 14 and plurality of receptacles 16 as described with reference to FIG. 1.

The system 50 includes an automated liquid handler 58 operable to transfer the plurality of samples 52 to and/or from the plurality of receptacles 56. The automated liquid handler 58 includes at least one arm 60 having a channel 62 within, each of the channel 62 having a tip 64 at one end of the channel 62. The automated liquid handler 58 can be similar to the automated liquid handler 18, as described with reference to FIG. 1.

The automated liquid handler 58 can be mounted on a first translation mechanism 66 capable of positioning the automated liquid handler 58 in X-Y direction with respect to the substrate 54. The arm 60 of the automated liquid handler 58 can be mounted on a second translation mechanism 68 for upward and downward motion of the arm 60 with respect to the plurality of receptacles 56.

A device 70 is provided to measure a property of the plurality of samples 52. In one embodiment, the property measured is a change in pressure with time across the tip 64 of the channel 62 while aspirating the plurality of samples 52, or dispensing the plurality of samples 52, or both. Typical time for aspiration and/or dispensing plurality of samples 52 using an automated liquid handler 58 is of the order of seconds with a time step of the order of milliseconds. In one embodiment, the change in pressure with time or the pressure differential is monitored for at least about 200 seconds. In some embodiments, the change in pressure with time or the pressure differential is monitored for at least about 100 seconds. In another embodiment, the change in pressure with time or the pressure differential is monitored for at least about 50 seconds. In another embodiment, the change in pressure with time is monitored for at least about 50 seconds with a time step of 10 milliseconds.

In some embodiments, the device 70 forms part of the automated liquid handler 58. However, the device 70 need not be part of the automated liquid handler 58 but can be in physical communication with the channel 62 of the automated liquid handler 58 and can measure the change in pressure with time across the channel 62 while aspirating or dispensing the plurality of samples 52. In FIG. 3, the device 70 is mounted on the arm 60 and in physical communication with the channel 62 to measure the change in pressure with time across the tip 64 of the channel 62. Exemplary device 70 includes pressure transducers, pressure sensing devices, piezoelectric devices or any combinations thereof.

Some of the commercially available automated liquid handlers such as, MicroLab® STAR have an in-built pressure transducer for monitoring and minimizing errors during liquid handling such as blockage of a tip. Embodiments of the present invention are operable to employ the in-built pressure transducers to measure the pressure differential across the tip 64 of the channel 62 and can relate the pressure differential to the rheological property of the plurality of samples 52.

The pressure differential measured using the device 70 can be analyzed using a data analysis system 72. In one embodiment, the data analysis system 72 is in a feed-back loop 74 with the device 70 and operable to send signals to the device 70 and/or receive signals from the device 70. For example, the data analysis system 72 can receive a continuous real-time signal on pressure differential from the device 70 while aspirating or dispensing the plurality of samples 52. In some embodiments, the data analysis system 72 is in a feed-back loop 76 with the automated liquid handler 58 and the device 70. For example, the data analysis system 72 can be operable to instruct the automated liquid handler 58 to aspirate the plurality of samples 52 at set aspiration rate and of a set aspiration volume and operable to receive the signals from the device 70 on pressure differential across the channel 62 while aspirating the plurality of samples 52. In one embodiment, the data analysis system 72 is a computer (not shown) interfaced with the device 70 and/or the automated liquid handler 58.

The data analysis system 72 can relate the pressure differential to the viscosity of the plurality of samples 52. In one embodiment, the viscosity of the plurality of samples 52 can be calculated using Hagen-Poiseulle equation;

$$μ = \frac{π}{8} \frac{Δ P}{L} \frac{{R}_{4}}{Q}$$

where, μ is the viscosity of the plurality of samples, ΔP is the pressure differential across the tip 64 of the channel 62, R is the radius of the tip 64 of the channel 62, L is the length of the tip 64 of the channel 62 and Q is the volume flow rate through the tip 64 of the channel 62. In the automated liquid handler, aspiration rate and/or dispensing rate and set aspiration volume and/or set dispensing rate of the plurality of samples 52 aspirated or dispensed can be set by the user. According to embodiments of the present invention, the volume flow rate (Q) is equivalent to the aspiration rate at low viscosity range of the plurality of samples of the order of about 1 cP to about 10,000 cP. In embodiments where viscosity of the plurality of samples is at the low viscosity range, the volume flow rate Q is equivalent to the aspiration rate, and pressure differential (ΔP) is proportional to the viscosity. In the high viscosity range, that is between a viscosity of about 10,000 cP to about 1000000 cP, flow restriction is severe through the tip 24 and as a result there is negligible flow at the on set of aspiration which results in increase in pressure across the channel to a maximum value followed by slow decay of pressure on commencement of flow through the tip 24 while aspirating the plurality of samples. In such embodiments, the pressure differential is proportional to the flow rate (Q) and thus inversely proportional to viscosity of the plurality of samples.

In the case of plurality of samples 52 exhibiting Newtonian fluid-type behavior, the measurement of the pressure differential at a single flow rate is sufficient to define the flow behavior. However, plurality of samples 52 exhibiting non-Newtonian fluid-type behavior, viscosity measurements need to be performed over a range of shear rates. In one embodiment, viscosity measurement over a range of shear rates can be obtained by determining the viscosity at more than one set aspiration rate or more than one set dispensing rate.

Commercially available tips typically have tapered ends so that the plurality of samples 52 are held by means of surface tension. However, the tapered end of tip 64 may severely restrict the flow through the tip 64 for the plurality of samples 52 having high viscosity. The aspiration or dispensing of the plurality of samples 52 having high viscosity takes longer through such tips and hence the change in pressure has to be measured over a longer period of time. Moreover, some of the commercially available automated liquid handlers 58 may not be equipped for handling plurality of samples 52 of such high viscosity. According to embodiments of the present invention, the tapered end of the tip 64 can be modified. In one embodiment, the tip 64 can be modified to include the range of rheological properties such as viscosity to be measured.

The tapered end of the tip 64 subjects the plurality of samples 52 to a range of shear rates because the wall shear rate is dependent on the varying diameter of the tip as described by the following equation:

$${γ}_{a} = \frac{4 Q}{π {R}^{3}}$$

where γₐ is the wall shear rate in the tip. For Non-Newtonian fluids, using a varying diameter tip may not provide a true viscosity measurement; rather the varying diameter tip can be used for relative viscosity screening. In some embodiments, the tapered end of the tip can be sliced to provide a wider mouth by which the viscosity measurements can be extended to non-Newtonian fluids. As will be appreciated, modifying the tapered end of the tip may advantageously minimize restriction to flow and may provide a laminar flow.

In some embodiments, the viscosity of the plurality of samples 52 can be determined at more than one tip geometry. As will be appreciated, determining the viscosity of the plurality of samples 52 at more than one tip geometry can provide a viscosity per shear rate of the plurality of samples 52, as shown by the equation on wall shear rate. In one embodiment, modifying the tip 64 includes modifying a diameter of the tip 64. In some embodiments, modifying the tip 64 includes modifying a length of the tip 64, or a shape of the tip 64 or any combinations thereof.

In some embodiments, the data analysis system 72 can relatively screen the plurality of samples 52 based on the pressure differential measured by the device 70 by aspirating the plurality of samples 52 at set aspiration condition, or by dispensing the plurality of samples 52 at set dispensing condition. The data analysis system 72 can sort the plurality of samples 52 from the pressure differential measured while aspirating and/or dispensing the plurality of samples 52. In some embodiments, the plurality of samples 52 can include at least one sample of known rheological property. In such embodiments, the data analysis system 72 can determine the rheological property of the plurality of samples 52 by comparing the pressure differential with that of samples of known rheological property.

In some embodiments, an empirical correlation can be formulated between the pressure differential of the plurality of samples 52 and the rheological property of the plurality of samples 52. In certain embodiments, the data analysis system 72 can determine the rheological property of the plurality of samples 52 from the empirical correlation. In some embodiments, a calibration curve or a standard curve can be generated based on the empirical correlation. The measured property of each of the plurality of samples 52 can be compared to the standard curve and the rheological property can be determined.

In some embodiments, the plurality of samples 52 can include at least one sample of known rheological property. In one embodiment, an empirical correlation can be formulated by measuring the pressure differential of at least one sample of known rheological property at the set aspiration condition. From the empirical correlation, a standard or standards can be generated. In some embodiments, a standard curve can be generated. The rheological property of each of the plurality of samples 52 can be determined from the standard curve by measuring the pressure differential, at the set aspiration condition, for each of the plurality of samples 52. In some embodiments, the data analysis system 72 is operable to formulate an empirical correlation between the pressure differential of the plurality of samples 52 and the rheological property of the plurality of samples 52 and by using the empirical correlation the data analysis system 72 can determine the rheological property of each of the plurality of samples 52. In another embodiment, at more than one set aspiration rate, the plurality of samples 52 can be aspirated and/or dispensed and from the pressure differential at more than set aspiration rate or dispensing rate while keeping the other settings of the automated liquid handler 58 fixed, the data analysis system 72 can determine the rheological property of the plurality of samples 52, wherein the rheological property is the viscosity per shear rate of the plurality of samples 52.

In one embodiment, the data analysis system 72 is operable to generate a pressure curve by plotting pressure against time while aspirating and/or dispensing the plurality of samples 52. For plurality of samples 52 having lower viscosity, the peak pressure is lower than that of the plurality of samples 52 having higher viscosity. The term “peak pressure” as used herein, refers to maximum value of pressure in a pressure curve generated while aspirating and/or dispensing the plurality of samples 52. Other information from the pressure curve which can be correlated to the rheological property of the plurality of samples 52 can include time required to reach the peak pressure, rate of decay of pressure and the final pressure at the end of aspiration or dispensing the plurality of samples 52. In one embodiment, pressure curve can be determined for at least one sample of known rheological property and by comparing the pressure curves, the rheological property of the plurality of samples 52 can be determined. In some embodiments, from the pressure curve generated over time while aspirating and/or dispensing the plurality of samples 52, the rheological property of the plurality of samples 52 can be determined in real-time.

In some embodiments, the data analysis system 72 is operable to measure the property of each of the plurality of samples 52 as a function of time, composition and/or temperature. In one embodiment, the system 50 is enclosed in an environmentally controlled chamber (not shown). In some embodiments, the system 50 includes a means for controlling and/or maintaining at least one of a temperature, humidity and atmosphere within the chamber. In certain other embodiments, the temperature of the tip 64 of the automated liquid handler 58 and/or the plurality of samples 52 can be controlled and/or maintained. In some embodiments, the system 50 includes a temperature controller (not shown) to maintain and/or control the temperature of the plurality of samples 52, or the tip 64, or both. In some embodiments, composition of the plurality of samples 52 can be varied and the rheological property of the plurality of samples 52 can be determined as a function of the composition. In one embodiment, one of the ingredients that constitute the plurality of samples 52 can be varied and the viscosity of the plurality of samples 52 with respect to the ingredient can be determined. In some embodiments, rheological property of the plurality of samples 52 can be determined as a function of time. For example, the viscosity of the plurality of samples 52 is determined at zero time and can be compared with the viscosity determination after several hours to determine the change in viscosity with time. In some embodiments, the rheological property of the plurality of samples 52 can be determined as a function of time, composition, temperature or any combinations thereof.

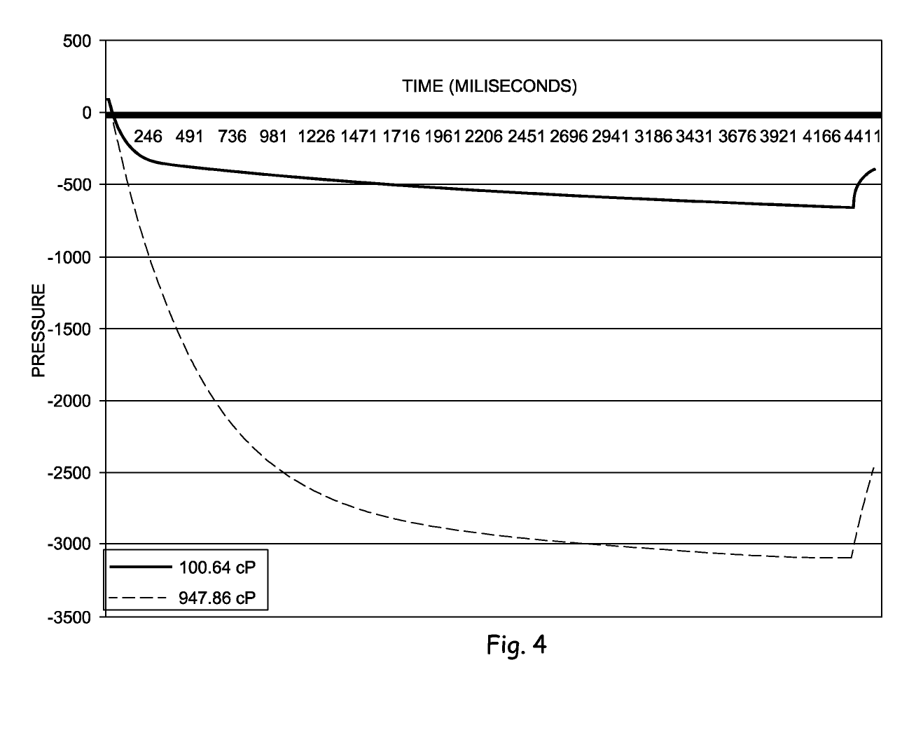

FIG. 4 is a plot of pressure over time of plurality of samples of known rheological properties as they are aspirated. FIG. 4 includes pressure curve of a sample of known rheological property having viscosity of about 100.64 cP and pressure curve of another standard having viscosity of about 947.86 cP. The pressure curve corresponding to standard having viscosity of 947.86 when compared to pressure curve corresponding to standard having viscosity of 100.64 exhibits higher peak pressure. Advantageously, viscosities of plurality of samples can be determined from the plot by plotting the pressure differential and comparing with the pressure curves of samples of known rheological properties.

Unlike the commercial viscometers, system 50 according to embodiments of the present invention is advantageous in that multiple samples can be analyzed simultaneously while aspirating and or dispensing the plurality of samples on the plurality of receptacles. Moreover, rheological behavior of both Newtonian and non-Newtonian samples can be determined Embodiments of the present invention can determine wide viscosity range of about 1 cP to about 1000000 cP. The plurality of samples that is tested remains undamaged after determining their rheological properties and can be reused. Exemplary rheological properties that can be determined includes viscosity, shear thinning, shear thickening, yield point, freeze thaw stability, heat age stability, pot life, cure rate, pour point and any combinations thereof.

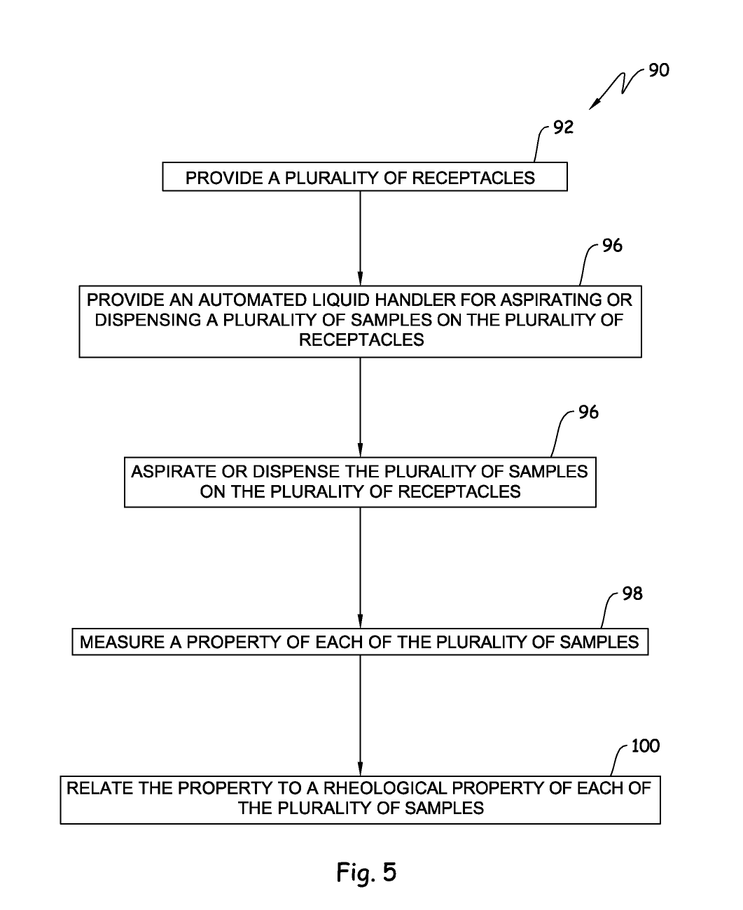

A method of testing a plurality of samples according to embodiments of the present invention is shown as a flow chart 90, in FIG. 5. At step 92, provide a plurality of receptacles. The plurality of receptacles is operable to receive and/or hold a plurality of samples within. In one embodiment, the plurality of samples can include a sample of known rheological property. The testing method as employed by embodiments of the present invention does not damage the plurality of samples. In some embodiments, the plurality of samples can be reused.

An automated liquid handler is provided, at step 94, to aspirate the plurality of samples or dispense the plurality of samples on the plurality of receptacles. The automated liquid handler includes at least two channels having a tip at one end of the channel. In some embodiments, geometry of the tip can be modified. In certain embodiments, modifying the tip includes modifying a diameter of the tip, or a length of the tip, or a shape of the tip, or any combinations thereof. Modifying the tip may advantageously broaden the range of rheological property such as viscosity that can be determined.

At step 96, aspirate or dispense the plurality of samples on the plurality of receptacles at a set aspiration condition or at set dispensing condition or both. In some embodiments, the plurality of samples can be aspirated or dispensed at more than one set aspiration rate or dispensing rate. Other automated liquid handler settings can include set aspiration volume and/or settling time.

A property of each of the plurality of samples can be measured, at step 98. The property is selected from mass of each of the plurality of samples dispensed in the plurality of receptacles, volume of each of the plurality of samples dispensed in the plurality of receptacles, flow rate while aspirating the plurality of samples or while dispensing the plurality of samples, time for aspirating the plurality of samples or dispensing the plurality of samples, pressure differential across the at least two channels while aspirating the plurality of samples at the set aspiration condition, or while dispensing the plurality of samples at the set dispensing condition, and any combinations thereof. In some embodiments, the property can be measured at a modified set aspiration condition or a modified set dispensing condition to enhance a sensitivity of the method. In one embodiment, a device is used to measure the property, wherein the device is a weighing balance, a piezoelectric device, a transducer, an optical device, a pressure sensing device, a liquid level sensing device, a flow meter, an inductive coil, a pressure transducer or any combinations thereof.

At step 100, the property is related to a rheological property of each of the plurality of samples. In one embodiment, relating the property includes comparing the property of the plurality of samples with respect to each other. In another embodiment, relating the property includes comparing a property of the plurality of samples with at least one sample of known rheological property. In some embodiments, relating the property includes comparing a property of each of the plurality of samples with a standard or a standard curve. In yet another embodiment, wherein the property measured is the pressure differential, a viscosity of the plurality of samples can be determined from Hagen-Poiseulle equation. Exemplary rheological properties of the plurality of samples that can be determined includes viscosity, pot life, shear thinning, shear thickening, pour point, yield point, freeze thaw stability, heat age stability, pot life, phase stability, temperature stability or any combinations thereof.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of testing a plurality of samples in parallel comprising:
providing a plurality of receptacles;
providing an automated liquid handler comprising at least two channels each having a tip and operable to dispense the plurality of samples in the plurality of receptacles at a set dispensing condition, or to aspirate the plurality of samples from the plurality of receptacles at a set aspiration condition, or both;
aspirating the plurality of samples from the plurality of receptacles at the set aspiration condition or dispensing the plurality of samples in the plurality of receptacles at the set dispensing condition, or both;
measuring a property of each of the plurality of samples at the set aspiration condition or set dispensing condition or both, wherein the property is selected from mass of each of the plurality of samples dispensed in the plurality of receptacles, volume of each of the plurality of samples dispensed in the plurality of receptacles, flow rate while aspirating the plurality of samples or while dispensing the plurality of samples, time for aspirating the plurality of samples or dispensing the plurality of samples, pressure differential across the at least two channels while aspirating the plurality of samples or while dispensing the plurality of samples, and any combinations thereof; and
relating the property to a rheological property of each of the plurality of samples.

2. The method of claim 1, wherein measuring the property comprises using a device, wherein the device comprises a weighing balance, an optical device, a transducer, a piezoelectric device, a pressure sensing device, a timer, a flow meter, a liquid level sensing device, an inductive coil, a pressure transducer or any combinations thereof.

3. The method of claim 1, wherein the plurality of samples comprises at least one sample of known rheological property.

4. The method of claim 3, wherein relating the property further comprises comparing the property of each of the plurality of samples with respect to the at least one sample of known rheological property.

5. The method of claim 1, wherein relating the property further comprises comparing the property of each of the plurality of samples with respect to each other.

6. The method of claim 1, wherein relating the property further comprises comparing the property of each of the plurality of samples with a standard or a standard curve or both.

7. The method of claim 1, wherein relating the property further comprises determining a viscosity of each of the plurality of samples using Hagen-Poiseulle equation.

8. The method of claim 1 further comprising measuring the pressure differential across the at least two channels at more than one set aspiration rate, or more than one set dispensing rate and relating the pressure differential at more than one set aspiration rate, or set dispensing rate to a viscosity per shear rate of each of the plurality of samples.

9. (canceled)

10. (canceled)

11. (canceled)

12. The method of claim 1 comprising measuring the pressure differential across the at least two channels at more than one diameter of the tip, or length of the tip, or shape of the tip, or any combinations thereof, and relating the pressure differential to a viscosity per shear rate of each of the plurality of samples.

13. The method of claim 1 further comprising measuring the property of each of the plurality of samples at a modified set aspiration condition or a modified set dispensing condition or both to determine the rheological property.

14. The method of claim 1, wherein the rheological property comprises viscosity, yield point, cure point, pour point, freeze thaw stability, heat age stability, pot life, shear thinning, shear thickening, phase stability, temperature stability, or any combinations thereof.

15. A system for testing a plurality of samples in parallel comprising:
a plurality of receptacles;
an automated liquid handler comprising at least two channels, the at least two channels each having a tip for aspirating the plurality of samples from the plurality of receptacles at a set aspiration condition, or dispense the plurality of samples in the plurality of receptacles at a set dispensing condition, or both;
a device for measuring a property of each of the plurality of samples at the set aspiration condition or set dispensing condition or both, wherein the property is selected from mass of each of the plurality of samples dispensed in the plurality of receptacles, volume of each of the plurality of samples dispensed in the plurality of receptacles, flow rate while aspirating the plurality of samples or while dispensing the plurality of samples, time for aspirating the plurality of samples or dispensing the plurality of samples, pressure differential across the at least two channels while aspirating the plurality of samples or while dispensing the plurality of samples, and any combinations thereof; and
a data analysis system configured to analyze the property of each of the plurality of samples and relate it to a rheological property of each of the plurality of samples.

16. The system of claim 15, wherein the data analysis system is configured to analyze the pressure differential at more than one set aspiration rate, or more than one set dispensing rate, and wherein the rheological property determined is a viscosity per shear rate of each of the plurality of samples.

17. (canceled)

18. (canceled)

19. The system of claim 15, wherein the system is configured to analyze the pressure differential at more than one diameter of the tip, or length of the tip, or shape of the tip, or any combinations thereof.

20. (canceled)

21. (canceled)

22. The method of claim 1, wherein the plurality of samples comprises a liquid, an emulsion, a gel, a blend, a dispersion, a melt, a polyelectrolyte, an oil, a grease, a paste or any combinations thereof.

23. The method of claim 1, wherein the plurality of samples remain undamaged on testing.

24. The system of claim 15, wherein the device comprises a weighing balance, an optical device, a transducer, a piezoelectric device, a pressure sensing device, a timer, a flow meter, a liquid level sensing device, an inductive coil, a pressure transducer or any combinations thereof.

25. The system of claim 15, wherein the tip is a disposable tip or a disposable needle.

26. The system of claim 15 further comprising a means for controlling a temperature of the plurality of samples, or the tip, or both.

27. The system of claim 15, wherein the data analysis system is configured to analyze the property of each of the plurality of samples as a function of time, composition, temperature, or any combinations thereof.
